(19) United States
(12) Patent Application Publication
(10) Pub. No.: US 2026/0111665 A1
(43) Pub. Date: Apr. 23, 2026

(54) EXTENSIBLE UNSTRUCTURED DATA FILE PARSING

(71) Applicant: Wells Fargo Bank, N.A., San Francisco, CA (US)

(72) Inventors: Diwakar Shiwan, Matthews, NC (US); Shashank Tyagi, Charlotte, NC (US); Vijay Daniel Pakalapati, Fort Mill, SC (US)

(21) Appl. No.: 19/365,008

(22) Filed: Oct. 21, 2025

Related U.S. Application Data
(60) Provisional application No. 63/709,948, filed on Oct. 21, 2024.

(51) Int. Cl. G06F 40/205; G06F 40/258; G06N 20/00

(52) U.S. Cl. CPC G06F 40/205; G06F 40/258; G06N 20/00

(57) ABSTRACT

Parsing unstructured data files using configuration-driven techniques. The process involves receiving a configuration file that defines patterns and rules, including logical page definitions, introduction section definitions, header column definitions, and data locator definitions. A page parser divides the unstructured data file into logical pages. An introduction parser extracts introduction and header sections from each page. A data processor extracts data objects from data sections, ensuring data continuity across pages. The processed data objects are stored in a database for analysis and retrieval. The configuration file may be generated using a machine-learning algorithm trained on various unstructured data files and corresponding configuration files.

### PRIORITY CLAIM

This patent application claims the benefit of priority, under 35 U.S.C. Section 119 to U.S. Provisional Patent Application Ser. No. 63/709,948 entitled “Extensible Unstructured Data File Parsing” filed on Oct. 21, 2024 to Diwakar, et al, which is hereby incorporated by reference herein in its entirety.

### TECHNICAL FIELD

Embodiments pertain to data processing and analysis technologies. Some embodiments relate to methods and systems for parsing unstructured data files using configuration-driven techniques.

### BACKGROUND

Unstructured data encompasses a wide range of information formats, including text files, emails, images, multimedia content, and mainframe data, which lack a predefined structure or organization. Mainframe data, often originating from legacy systems, can be particularly challenging due to its complex and varied formats. Conversion of this data to different formats remains relevant due to the continued use of mainframe systems in critical business operations and the need for that data to integrate with more modern systems. Despite its abundance, unstructured data presents significant challenges for processing and analysis due to its inherent complexity and variability.

Parsing unstructured data is desirable because it enables the extraction of meaningful information from otherwise chaotic and disorganized content. By converting unstructured data into a structured format, organizations can gain valuable insights, improve decision-making, and enhance operational efficiency. Effective parsing allows for the identification of patterns, trends, and relationships within the data, facilitating tasks such as data mining, sentiment analysis, and information retrieval. As a result, the ability to parse unstructured data is crucial for leveraging its full potential and driving innovation across various industries.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a message sequence chart showing a parsing of file using a configuration file according to some examples of the present disclosure.

FIG. 2 illustrates a logical diagram of a file processing service that processes unstructured data files, such as an unstructured data file using configuration files, according to some examples of the present disclosure.

FIG. 3 illustrates a flowchart of a method of parsing an unstructured file according to some examples of the present disclosure.

FIG. 4 is a block diagram illustrating an example of a machine upon which one or more embodiments may be implemented.

FIGS. 5-10 illustrate example anonymized data files, according to some examples of the present disclosure.

FIG. 11 illustrates examples of expression evaluation according to some examples of the present disclosure.

### DETAILED DESCRIPTION

Unstructured data files, such as mainframe data, present significant challenges due to their lack of predefined format and organization. Traditional parsing methods often rely on rigid pattern-matching techniques, which can lead to inaccuracies and inefficiencies when dealing with complex data structures. These methods typically do not account for the underlying context and data flow, resulting in errors during data extraction. Moreover, code developed to parse one type of unstructured data file is often not adaptable to other file types, necessitating the creation of new parsing solutions for each unique data format. This lack of flexibility increases development time and costs, while also limiting the ability to efficiently process diverse data sources. A more sophisticated approach that incorporates an understanding of structure and context is needed to address these issues, allowing for logical segmentation and improved accuracy in data extraction.

Disclosed in some examples are methods, systems, devices, and machine-readable mediums that provide for extensible parsing of unstructured data files that utilize an awareness of file structure, context, and data flow. This approach allows for logical segmentation of data into sub-parts such as pages, headers, and data sections to facilitate more accurate and efficient data extraction. The solution is extensible, utilizing a configuration file to define patterns and rules, enabling adaptability to various file types and scenarios. By employing customizable parsing techniques, including regular expressions and data row handling, the system provides users with greater control and reduces errors associated with traditional methods. This flexibility allows for the seamless integration of new data formats, minimizing development time and costs while maximizing the potential for data-driven insights.

In the disclosed system, patterns serve not just as locations for data extraction but as markers to divide the file into logical sub-structures like Pages, Page Headers, Page Sub-Headers, and Data Sections, along with more granular entities. The process does not require the file to have a predefined page structure; instead, the system can logically interpret the structure based on the file's content. By breaking the file into sub-parts, the system can more easily parse and capture data, allowing for flexibility, such as appending sub-headers only to relevant pages. This approach provides users with greater control and reduces errors compared to traditional methods that rely solely on pattern recognition.

The method begins by receiving a configuration file, which may be in various formats such as a YML (YAML Ain't Markup Language) format or spreadsheet format (e.g., Excel), which outlines the patterns and rules for parsing the unstructured data file. This configuration file serves as a guide, defining logical sub-parts such as pages, page headers, page sub-headers, and data sections. The process starts with analyzing the unstructured data file to identify these sub-parts, using the configuration file to detect repeatable patterns known as PageMarkers. These markers help in logically separating the file into pages or sections, providing a structured approach to data extraction. Note that, the unstructured data may already have “pages” that are based upon some quantity or size of the data that may fit on a single printed page or are based upon or related to some other pagination scheme. The disclosed methods may not rely upon these page definitions. Instead, the system may utilize a more logical definition of page that relies upon the data patterns and flow.

Once the file is divided into pages, the method extracts intro and header sections from each page. These sections establish the context and structure necessary for accurate data extraction. The intro section typically contains constant data elements, while the header section acts as a marker for the data that follows. By identifying these sections, the method ensures that the data extraction process is both precise and efficient.

After establishing the context, the method applies customizable parsing techniques to extract data objects from the data sections of each page. These techniques may include regular expressions, data row start positions, and handling of multi-line data. The extracted data objects are then processed for storage in a database, with specific logic applied to manage data continuity across pages and handle any special conditions. This structured approach allows for greater control and reduces errors, providing a flexible and efficient solution for parsing unstructured data files.

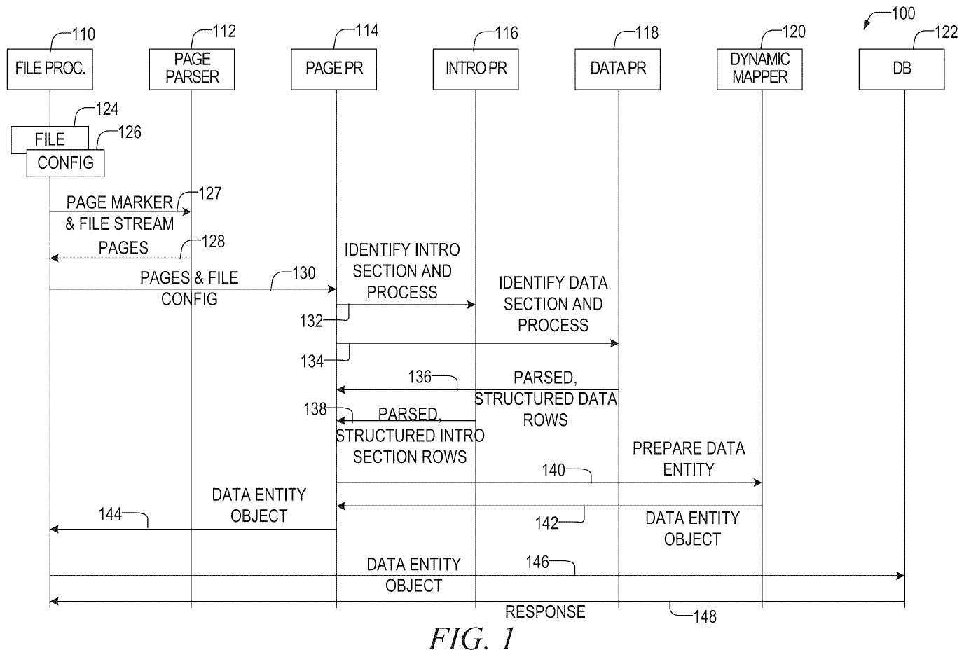

FIG. 1 shows an overview of the file parsing and illustrates a message sequence chart 100 illustrating the parsing of an unstructured data file 124 using a configuration file 126. The process begins with a file processing component 110, which receives the unstructured data file 124 and the configuration file 126. The configuration file 126 contains patterns and rules necessary for parsing. A page parser component 112 utilizes the configuration file 126 to divide the unstructured data file 124 into logical pages 128. This division is based on the logical page definitions provided in the configuration file 126. The page parser component 112 outputs pages and the configuration file 130 to a page processing component 114.

The page processing component 114 sends the file config and pages 132 to the intro processing component 116 which identifies the intro section and processes the intro section using the intro section definitions from the configuration file 126. This step results in parsed, structured intro section rows 138, which are then returned to the page processing component 114.

Simultaneously, the page processing component 114 sends the configuration file and the data 134 to the data section processing component 118, which identifies the data section and processes the data section using the data locator definitions. This results in parsed, structured data rows 136, which are sent back to the page processing component 114.

The page processing component 114 then sends the parsed data in a request 140 to prepare the data entity to the dynamic mapper component 120. The dynamic data entity mapper component 120 creates data entity object 142 including the data, which is sent back to the page processing component 114. Page processing component 114 may send the data entity object 144 back to the file processing component 110. File processing component 110 then sends the data entity object 146 to the database 122 for storage. The process concludes with a response 148, indicating the successful parsing and storage of the data entities in the database 122.

Creating a configuration file may be done manually by analyzing the unstructured file to determine patterns. In other examples, various machine-learning algorithms may be used to automatically determine the patterns. For example, a data set of unstructured files may have configuration files manually generated and used to train a neural network. The neural network may then be used to generate configuration files for unstructured files that were not part of the training data.

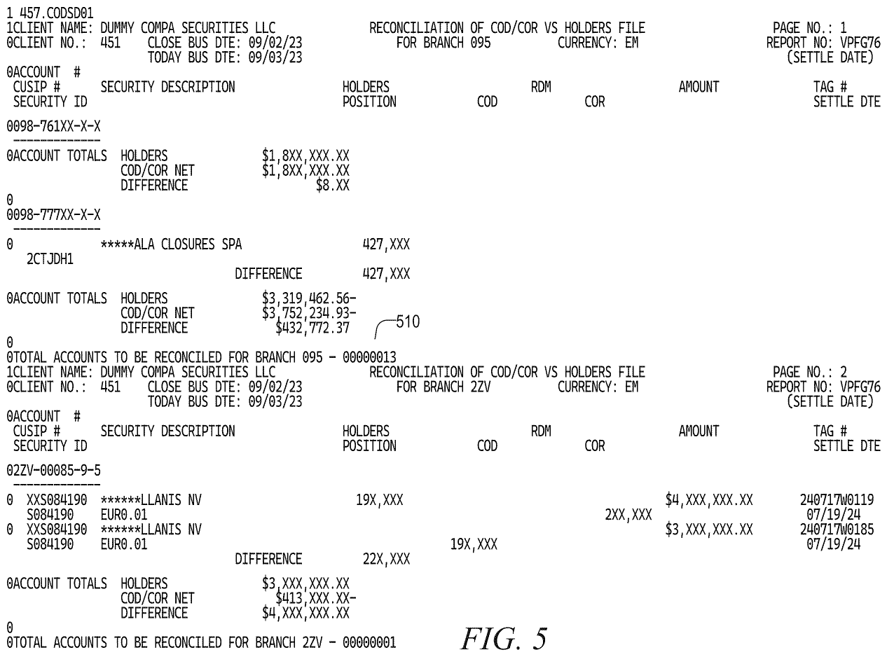

Regardless of how the configuration file is generated, the first step is generating the configuration file. An example data file is shown by FIG. 5. First, the file may be analyzed to detect any repeatable patterns that could be used to break the data into smaller processable units, termed “pages.” As noted these pages do not necessarily correspond to any pages that may be present in the data. The pattern used to identify pages is called a “PageMarker”. In the example file, a PageMarker may be “0TOTAL ACCOUNTS TO BE RECONCILED FOR BRANCH” shown by reference number 510. While the example has a “PAGE NO.:” field, this may be unsuitable for logically extracting data from the file because of limitations for processing some of the data that is used beyond the given page number. For example, the account numbers mentioned on top of the data section are used across many pages until the next account details are not found. Furthermore, in the subsequent screenshots, the PageMarker is encountered next in PAGE NO.: 3. So the pages are defined in a custom way to more accurately process the data.

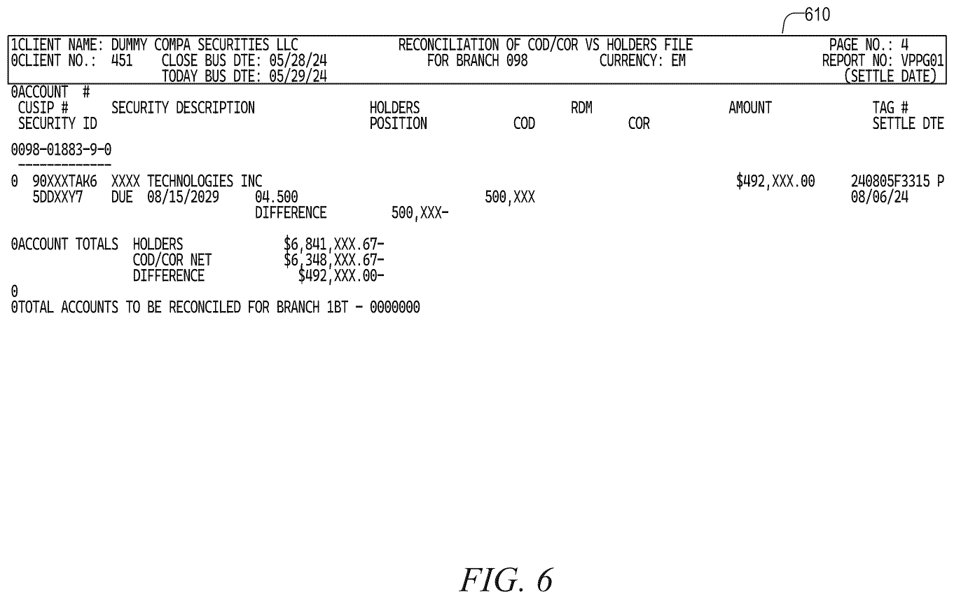

Next, the file is analyzed to further break the page into smaller units where the data remains constant for all the data elements of the page. For example, an introduction or keyword and some part which forms the independent data element or rows of data. For example, this data may be just headers that are used to identify what data it represents. For example, in FIG. 6, box 610 shows an introduction section which has keywords that remain constant for all the data elements of the page and they will be stored for each data row from this page. Example data element labels are client name, client number, close business date, today business date, and the like. Regular expressions, string pattern matching, and string operations may be used to extract the associated data elements with these keywords.

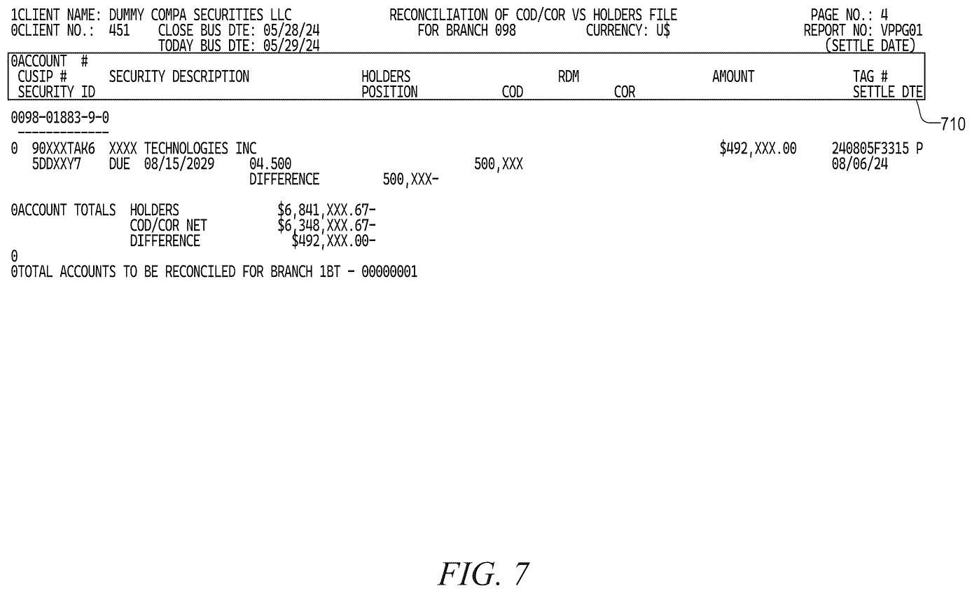

Next, the file is analyzed to identify headers that define data elements below them and are used as markers. These are defined as headers as shown with box 710 in FIG. 7. In some examples, data is not extracted from these elements as they are simply markers which define data which follows the sequence and are identified as the names described in the header. The headers are identified using regular expressions.

The above two elements or subsections form a section called “IntroSection” or common section that may be handled in special ways. The IntroSection may be identified and extracted using regular expressions. Any data which remains constant for the all elements of the page, or are just used as markers, or which provide introductory information about what the below data elements constitute form the Intro Section. As an example, a bank statement of your account has some introduction on the top which includes your name, account information, bank details and relevant dates. Anything which does not constitute uniquely identifiable individual data rows and appears before the start of these data rows, may be classified as an intro section. There may be a possibility that some elements withing the data section are not used or are not relevant to the data section, but if they are placed in the report below the start of data section, they are not part of this intro section. Data in the intro row is saved to every row of data in the database.

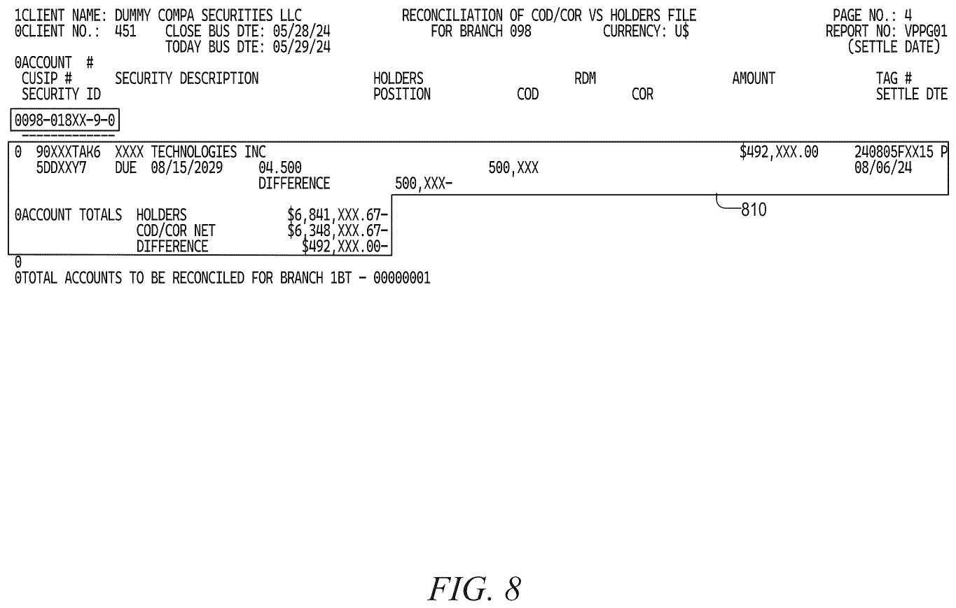

Next the data section is identified. This is shown as box 810 in FIG. 8. The data section is used to identify and extract data and populate an individual row in a database. The data section represents any transaction, operation, or any business item. To extract the data, many different techniques may be utilized. These techniques could be a combination of below mentioned approaches for these rows to extract the data correctly. The techniques are: Data Row Start Position (e.g., the text column in which the data starts), Regular Expressions, each data element's start and end index (e.g., the text column in which the data starts and ends), data flow, identifier keywords, a number of mandatory data elements in each row, a minimum number of data elements required to qualify for a particular row, any Row which can be ignored or not required for data computation, and any data row which repeats itself. As an example, to extract the “90XXXTAK6” field of FIG. 8, the start position of the column can be 4th column and end position can be 13th. If the data flow includes any movement of the start or end position the system can adjust these accordingly. For example, the start position can be the second column and if in some case data ends at 14th position, the end can be utilized to be the 14th column.

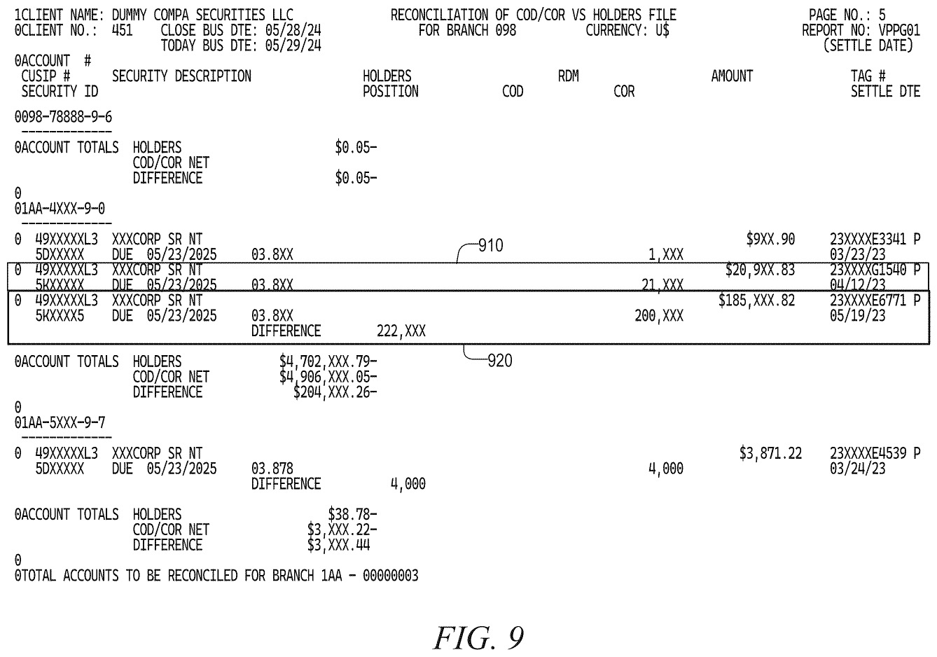

In some examples, data flow can be defined by how the data is presented in the unstructured file which constitutes as one row of data in the database. For example in the file shown in FIG. 9, there are three rows in the unstructured file that create one unique row record in the database. However, in some examples, it may be possible that this can change to only two rows in the unstructured file. As an example of how dataflow may be used by the system, in FIG. 9, the data changes from being two rows in box 910 to three rows in the box 920.

After applying these techniques, the analysis also follows any special needs that may be required to identify the data elements. For example data may be needed from 2 different data elements to be calculated or any data being appended. For that we have defined the calculations in a data Entity class and extracted the implementation to a separate file, in the application.

An example configuration file in YML format is now described. A PageMarker section first defines a name of the file for which the configuration is defined. Then the page-marker regular expression that will be used to split the file into pages is defined:

1 FileConfig:

| | |
|---|---|
| 2 | file-name: “CODSD01” |
| 3 | file-location: “” |
| 4 | page-marker-regex: “0TOTAL ACCOUNTS TO BE RECONCILED FOR BRANCH |

\\w+ - \\d+”

Next, there is a section that defines unwanted information that is discarded. For example, there may be a number of lines from the start of the file to delete and we may have a configuration to delete n number of lines from the start of the file.

```
  5 top-lines-to-delete: 0
  6 bottom-lines-to-delete:
  7 lines-to-delete-contains:
  8 - “ ------------”
  9 - “1CLIENT NAME: DUMMY COMPA SECURITIES LLC RECONCILATION OF
COD/COR
    VS HOLDERS FILE PAGE NO.:”
  10 - “ RECONCILIATION OF COD/COR VS HOLDERS FILE PAGE NO.:”
  11 - “0ACCOUNT #”
  12 - “CUSIP # SECURITY DESCRIPTION HOLDERS RDM AMOUNT
TAG #”
  13 - “SECURITY ID POSITION COD COR SETTLE DTE”
```

Next, the configuration defines the Intro Section using regular expressions, string manipulation and/or string operations. In some examples, the regular expression is used to identify the line which has the keywords and the patterns that correspond to the keywords, as shown below:

| | |
|---|---|
| 14 | keyword: |
| 15 | keyword-line-start: 1 |
| 16 | keyword-line-end: 3 |
| 17 | keyword-finder: |
| 18 | - line-regex “1CLIENT NAME:\\x*RECONCILIATION OF\\s*(.*?)\\s*PAGE |

NO.:\\s*(\\d+)”

| | |
|---|---|
| 19 | keywords: |
| 20 | - “clientName” |
| 21 | - “reconOf” |
| 22 | - “page” |
| 23 | - line-regex: “0CLIENT NO\\.:\\s*(.*)\\s*CLOSE BUS DTE:\\s*(.*?)\\s*FOR |

BRANCH\\

| | |
|---|---|
| | s*(.*?)\\s*CURRENCY:\\s*(.*?)\\s**REPORT NO: (.*?)\\s* |
| 24 | keywords: |
| 25 | - “clientNbr” |
| 26 | - “closeBusDate” |
| 27 | - “branch” |
| 28 | - “currency” |
| 29 | - “reportNumber” |
| 30 | - “page” |
| 31 | - line-regex: “TODAY BUS DTE: (\\D{2}/\\D{2}/\\D{2})” |
| 32 | keywords: |
| 33 | - “todayBusinessDate” |

Next the configuration defines the header columns. It is used to identify the rows containing column details and is used to mark the end of intro section. It acts as a marker to separate the IntroSection and Data Section based on the column Values.

| | |
|---|---|
| 33 | on-demand: |
| 34 | on-demand-map: |
| 35 | “max-column-end”: 133 |
| 36 | “max-ignorable-lines-in-multiline-block”: 1 |
| 37 | column-mapping: |
| 38 | column-header: |
| 39 | - header-regex: “0ACCOUNT\\s+#” |
| 40 | header-lines: 1 |
| 41 | - header-regex: “ CUSIP #\\s+SECURITY |

DESCRIPTION\\s+HOLDERS\\s+RDM\\s

| | |
|---|---|
| | +AMOUNT\\s+TAG #” |
| 42 | header-lines: 2 |
| 43 | - header-regex: “ SECURITY ID\\s+POSITION \\s+COD\\s+COR\\s+SETTLE |

DTE”

| | |
|---|---|
| 44 | header-lines: 3 |

Below the Headers, there are some additional helpers to identify data. If there are some special characters which are present and have no meaningful value to the data, for example a ‘$’ symbol in a numeric field that will cause issues when saving numbers in a numeric data field of the DB, the non-numeric characters will be removed. Some of them are handled using this config, while some may be handled by the application automatically.

| | |
|---|---|
| 45 | data-section-regex: “\\s{2,}” |
| 46 | second-section-start: 0 |
| 47 | deletable-special-characters: |
| 48 | - “*” |
| 49 | - “$” |

The next sections in the configuration section define the starting position for each row of data, which forms one complete row of data in the database. In some examples, it may be one or more rows in the raw file. The configuration sections then define, for each row, the maximum number of data elements in each row of the data of a multirow block that form one data row in a database. For example, the multiline-data-start-columns-position: field defines, for each row, the column position where the data starts. The multiline-data-section-columns-count defines for each row, the number of data elements that can be found in that particular row in the unstructured data file. The multiline-data-section-ignorable-count defines columns in each line that are to be ignored. Thus, for line 1 in the example below, the first two columns are ignored.

| | |
|---|---|
| 50 | multiline-data-char-positions: |
| 51 | multiline-data-start-columns-position: |
| 52 | - “1:0” |
| 53 | - “2:3” |
| 54 | - “3:34” |
| 55 | multiline-data-section-columns-count: |
| 56 | - “1:7” |
| 57 | - “2:5” |
| 58 | - “3:1” |
| 59 | multiline-data-section-ignorable-count: |
| 60 | - “1:2” |
| 61 | - “2:1” |
| 62 | - “3:0” |

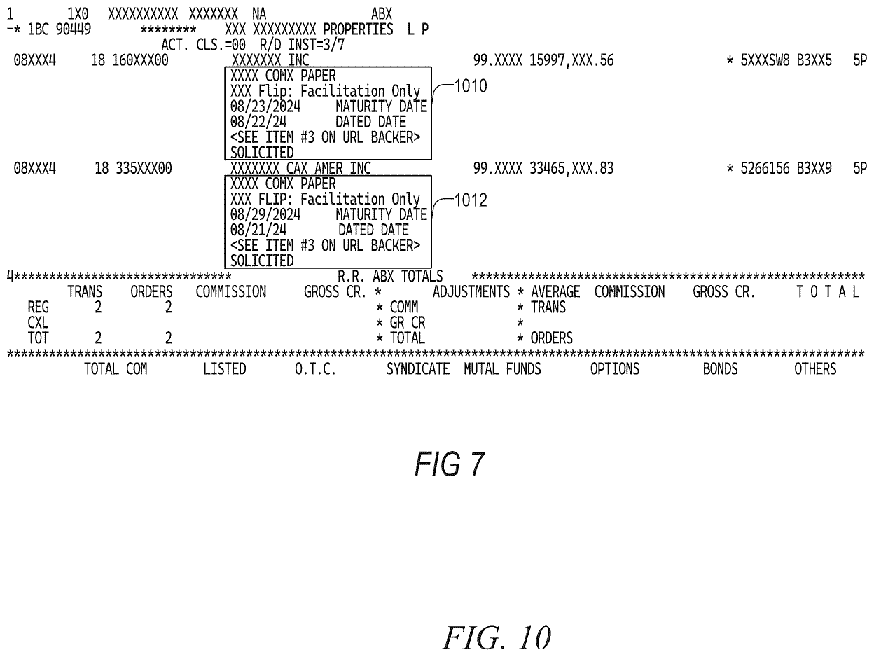

In some examples, some column data, primarily comments or description sections, span across multiple rows, so the configuration file may include definitions to handle multiple line data. For example, the isMultilineDescOrComment field may be set to Y indicating YES and the multiline-desc-char-start-end-position shows the start and the end of the any text which can be called a description or comment section in the data file, this is an exception to the number of rows that are expected to be in a particular data block. For example, if three rows are expected in the unstructured text file for every unique database record, there may be an additional row which may only contain some text information. For example, in FIG. 10 the description in boxes 1010 and 1012 is not limited and it can be extended beyond the normal two rows of data we are expecting. The isMultilineDescOrComment and multiline-desc-char-start-end-position configuration parameters are used to handle this scenario.

Next, the configuration file may be configured to handle special conditions that may be encountered while processing a file. For example:

| | |
|---|---|
| 63 | isMultilineDescOrComment : “Y” |
| 64 | multiline-desc-char-start-end-position: “14;46” |
| 65 | isMultiSection: “N” |
| 66 | handleSpecialCondition: |
| 67 | - “0ACCOUNT TOTALS HOLDERS” |
| 68 | - “COD/COR NET” |
| 69 | - “DIFFERENCE” |

Special conditions are an exception to the normal flow of data. For example, if one or more lines of data are in completely different formats and do not adhere to any header or any standard pattern that has been pre-defined and if it cannot be ignored or deleted and some data is being used from those lines, the special conditions may be used to handle these conditions separately in the data section. Regular expressions and data flow may be used in conjunction to identify these data elements and extract the data separately to be used while creating the record in the database.

Next, the configuration file describes the data elements using the start and end position in the unstructured data file. Each column value defines the name of the column, start, and end position of the characters and how it is mapped with the database column. Other elements specify whether the field is mandatory or not:

| 70 | column-values: | |
|---|---|---|
| 71 | - | column: “CUSIP #” |
| 72 | | column-line-pos: 1 |
| 73 | | columns-pos-start: 3 |
| 74 | | columns-pos-end: 13 |
| 75 | | column-value-mandatory: false |
| 76 | | column-table-name: “Cusip” |
| 77 | - | column: “SECURITY DESCRIPTION” |
| 78 | | column-line-pos: 1 |
| 79 | | columns-pos-start: 14 |
| 80 | | columns-pos-end: 46 |
| 81 | | column-value-mandatory: true |
| 82 | | column-table-name: “Security_Description' |
| 83 | - | column: “HOLDERS POSITION” |
| 84 | | column-line-pos: 1 |
| 85 | | columns-pos-start: 47 |
| 86 | | columns-pos-end: 67 |
| 87 | | column-value-mandatory: false |
| 88 | | column-table-name: “Holders” |
| 89 | - | column: “RDM #” |
| 90 | | column-line-pos: 1 |
| 91 | | columns-pos-start: 68 |
| 92 | | columns-pos-end: 94 |
| 93 | | column-value-mandatory: false |
| 94 | | column-table-name: “Rdm” |
| 95 | - | column: “AMOUNT” |
| 96 | | column-line-pos: 1 |
| 97 | | columns-pos-start: 95 |
| 98 | | columns-pos-end: 118 |
| 99 | | column-value-mandatory: false |
| 100 | | column-table-name: “Amount” |
| 101 | - | column: “TAG #” |
| 102 | | column-line-pos: 1 |
| 103 | | columns-pos-start: 119 |
| 104 | | columns-pos-end: 130 |
| 105 | | column-value-mandatory: false |
| 106 | | column-table-name: “Tag_No” |
| 107 | - | column: “CODE” |
| 108 | | column-line-pos: 1 |
| 109 | | columns-pos-start: 131 |
| 110 | | columns-pos-end: 133 |
| 111 | | column-value-mandatory: false |
| 112 | | column-table-name: “Trade_Status” |
| 113 | - | column: “SECURITY ID” |
| 114 | | column-line-pos: 2 |
| 115 | | columns-pos-start: 3 |
| 116 | | columns-pos-end: 13 |
| 117 | | column-value-mandatory: false |
| 118 | | column-table-name: “Security_ID” |
| 119 | - | column: “SECURITY DESCRIPTION2” |
| 120 | | column-line-pos: 2 |
| 121 | | columns-pos-start: 14 |
| 122 | | columns-pos-end: 46 |
| 123 | | column-value-mandatory: false |
| 124 | | column-table-name: “Sec_desc2” |
| 125 | - | column: “COD” |
| 126 | | column-line-pos: 2 |
| 127 | | columns-pos-start: 55 |
| 128 | | columns-pos-end: 73 |
| 129 | | column-value-mandatory: false |
| 130 | | column-table-name: “COD” |
| 131 | - | column: “COR” |
| 132 | | column-line-pos: 2 |
| 133 | | columns-pos-start: 77 |
| 134 | | columns-pos-end: 96 |
| 135 | | column-value-mandatory: false |
| 136 | | column-table-name: “COR” |
| 137 | - | column: “SETTLE DTE” |
| 138 | | column-line-pos: 2 |
| 139 | | columns-pos-start: 119 |
| 140 | | columns-pos-end: 128 |
| 141 | | column-value-mandatory: false |
| 142 | | column-table-name: “Settle_Date” |
| 143 | - | column: “DIFFERENCE” |
| 144 | | column-line-pos: 3 |
| 145 | | columns-pos-start: 45 |
| 146 | | columns-pos-end: 64 |
| 147 | | column-value-mandatory: false |
| 148 | | column-table-name: “Difference” |
| 149 | column-keyword-regex: | |
| 150 | - line-regex: “” | |
| 151 | | keywords: |
| 152 | | - “” |

The parser utilizes the configuration file to parse the unstructured data. In some examples, the data files are delivered into a storage folder where a poll process periodically polls for new files. The YML configuration files may be placed in another folder where the name of the configuration file corresponds to the name of the incoming raw data file. In other examples, a data structure matching names or extensions of raw data files to configuration files may be provided. In still other examples, the configuration files may be rows in a database or table that identifies each raw file. For example:

| | | | | | | |
|---|---|---|---|---|---|---|
| sectionName: | | | | | | |
| DVNDVSY | | | | | report | entity |
| identifier | fileName | pageMarker | fileHeaders | linesToDelete | Keywords | Name |

| | | | | | |
|---|---|---|---|---|---|
| DVNDVSY | c:\Users\ | DAILY | 320:0 N T INT | ′.* * * * * * | DVNDVSY |
| | processingDone\ | DIVIDEND | OFFSET W/H | * * * * | |
| | test_input\ | SYSTEM | W/H | CLIENT; 0 | |
| | dvndvsh | PROCESSED | DATE I | X X X X X | |
| | | | ACCOUNT | X X X | |
| | | | 3TAG | END OF | |
| | | | ORG | CLIENT | |
| | | | POSITION | | |
| | | | MEMO | | |
| | | | NET | | |
| | | | AMOUNT | | |
| | | | ACCOUNT | | |
| | | | RATE | | |
| | | | AMOUNT | | |
| | | | MESSAGE; 720:0 | | |
| | | | SECURITY | | |
| | | | INFORMATION | | |
| | | | REC PAY | | |
| | | | DATE DATE | | |
| | | | RATE | | |
| | | | MESSAGE | | |

sectionName: DVNDVSY

| deletable | intro | data | | | |
|---|---|---|---|---|---|
| Special | Section | Section | 320.multiLineintro | 720.multiLineintro | 320.startSubString |
| Characters | Regex | Regex | CharPositic | CharPositic | Position |
| *; $; # | \x(2,) | \x(2,) | ′.* * * * * * * * * | Line | 1; 11 |
| | | | * * * | 1:0; 12; 43; 103; 121* | |
| | | | CLIENT; 0X X X | * line2:; 15; 103; 123 | |
| | | | X X X X X END | | |
| | | | OF CLIENT | | |

In yet additional examples, the configuration files may be part of the parser's code object that is built into the executable or interpretable code object.

Once the file poll process sees a file in the folder a first level validation happens to check if there is a configuration present in the YML format or excel format. If it finds the configuration for the incoming file, it is picked up for processing, otherwise an exception is thrown notifying that the configuration is missing for this file.

Once the file is picked up for processing, it is processed as a batch service, where the system determine what kind of fileParser will be used to process this file. For example:

FileProcessingService.java

| | |
|---|---|
| 39 | public void processFile(String filePath) {\ |
| 40 | log.info(*inside processFile...input filePath-->“ + filePath); |
| 41 | try { |
| 42 | String key = CommonUtilities.extractFileName(filePath); |
| 43 | log.info(“key:” + key); |
| 44 | FileConfig fileConfig = null; |
| 45 | |
| 46 | if(!CommonUtilities.isNullOrEmpty(fileWatcherConfigDirectory) ) { |
| 47 | |
| 48 | fileConfig = CommonUtilities.readConfigurationFromYmlFile(key, |
| | fileWatcherConfigDirectory); |
| 49 | } |
| 50 | else{ |
| 51 | log.error(String.format(“Config values for [file_watcher_config_directory] |
| | is null or empty! : [%s]”,fileWatcherConfigDirectory)); |
| 52 | return; |
| 53 | } |
| 54 | if (fileConfig == null \|\| fileConfig.isEmpty( )) { |
| 55 | Map<String, Map<String, String>> configMap = CommonUtilities. |
| | readConfigurationSectionsFromExcel(filename:*xxxxxxxxxxxx.xlsx”); |
| 56 | if (configMap.containsKey(key)) { |
| 57 | Map<String, String> config = configMap.get(key); |
| 58 | FileParser<?> parser = |

fileParserFactory.getFileParser(config.get(IDENTIFIER));

| | |
|---|---|
| 59 | parser.setFileName(filePath); |
| 60 | parser.setEntityName(key); |
| 61 | parser.setConfig(config); |
| 62 | genericTasklet.setFileParser(parser); |
| 63 | }else{ |
| 64 | log.error(“Config not available for this file”); |
| 65 | } |
| 66 | } else { |
| 67 | FileParser<?> parser = |

fileParserFactory.getFileParser(fileConfig.getFileName( ));

| | |
|---|---|
| 68 | parser.setFileName(filePath); |
| 69 | parser.setEntityName(key); |
| 70 | parser.setYmlConfig(figConfig); |
| 71 | genericTasklet.setRunTime(System.currentTimeMillis( )); |
| 72 | genericTasklet.setFileParser(parser); |
| 73 | } |
| 74 | genericJobRunner.runJob(filePath); |
| 75 | |

log.info(“******************************************************************”

+“\n’);

| | |
|---|---|
| 76 | } catch (Exception e) { |
| 77 | log.error(“Exception in FileProcessingService.processFile( ) : ” + e.getMessage( )); |
| 78 | } |
| 79 | } |
| 80 | } |

The file parsers are implemented and annotated with the “@FileParserEntity(entityName={“CODREC”,“CODSD01”})” where CODSD01 represents the unstructured raw data file name. This annotation is helpful in adding any number of files that can be processed using the same fileparser, as is the case with CODREC file, in this example. This provides code reusability and extending the functionality just by adding a configuration. For example:

FileProcessingService.java

| | |
|---|---|
| 46 | @Component |
| 47 | @Scope(ConfigurableBeanFactory.SCOPE_PROTOTYPE) |
| 48 | @FileParserEntity(entityName = {“CODRED”,”CODSD01”}) |
| 49 | @FileP |

The Database entity, which is used to store the final parsed data, is also given the same name to maintain conformation and simplicity throughout the application. For example:

CODSDO1.java

| 9 | |
|---|---|
| no usages | |
| 10 | @Entity |
| 11 | @Table(name = “bps_CODSD01_DTL”) |
| 12 | public class CODSD01 extends BaseEntity { |
| | 2 usages |
| 13 | @Column(name = “Client”) |
| 14 | private Double client; |
| 15 | |
| | 2 usages |
| 16 | @Column(name = “Process_Date”) |
| 17 | private Instant processDate; |
| 18 | |
| | 2 usages |
| 19 | @Nationalized |
| 20 | @Column(name = “Cusip”, length = 254) |
| 21 | private String cusip; |
| 22 | |
| | 2 usages |
| 23 | @Nationalized |
| 24 | @Column(name = “Security_Id”, length = 254) |
| 25 | private String securityId; |
| 26 | |
| | 2 usages |
| 27 | @Nationalized |
| 28 | @Column(name = “Sec_Desc1”, length = 254) |
| 29 | private String secDesc1; |
| 30 | |
| | 2 usages |
| 31 | @Nationalized |
| 32 | @Column(name = “ Sec_Desc2”, length = 254) |
| 33 | private String secDesc2; |

Further when the fileparser is determined using the factory method based on the input file name, we need to split the unstructured raw data file into smaller processing units, called pages. To split the raw data file into pages, another process called PageParsers is defined, which reads the file and return a bunch of pages. The determination of PageParsers also happen using the name of the incoming file. These pageparsers also use the annotation “@PageParserEntity(entityName={“CODSD01”,“CODREC”})” so as to provide code reusability and extension using configuration, in the same way as file Parser provide. For Example:

CodCorPageParser.java

| | |
|---|---|
| 19 | @Component |
| 20 | @Scope(ConfigureableBeanFactory.SCOPE_PROTOTYPE) |
| 21 | @PageParserEntity(entityName = {“CODSDO1”,“CODREC”}) |
| 22 | public class CodCorPageParser extends PageParser { |
| 23 | |
| | 1 usage |
| 24 | @Autowired |
| 25 | public CodCorPageParser(IntroHandler introHandler, DataHandler dataHandler, |

FileParserFactory

| | |
|---|---|
| | fileParserFactory) { |
| 26 | super(introHandler, dataHandler, fileParserFactory); |
| 27 | } |
| 28 | |
| 29 | @Override |
| 30 | public List<Page> parsePages(List<String> lines) throws IOException { |
| 31 | |
| 32 | FileConfig fileConfig = fileParser.getYmlConfig( ); |
| 33 | List<Page> pages = new ArrayList<>( ); |
| 34 | Page currentPage = new Page( ); |
| 35 | Section currentSection = new CommonSection( ); |
| 36 | |
| 37 | if(fileConfig != null) { |
| 38 | |
| 39 | int topLinesToDelete = fileConfig.getTopLinesToDelete( ); |
| 40 | for(int i=1; i<=topLinesToDelete; i++) { |
| 41 | lines.remove( index 0); |
| 42 | } |
| 43 | processPageForListOfLines(fileConfig, lines, pages, currentPage, |

currentSection);

| | |
|---|---|
| 44 | StringBuilder pageData = new StringBuilder( ); |
| 45 | for (Page page : pages) { |
| 46 | pageData.append(page.toString( )); |
| 47 | } |
| 48 | return pages; |
| 49 | } |
| 50 | return pages; |
| 51 | } |
| 52 | |

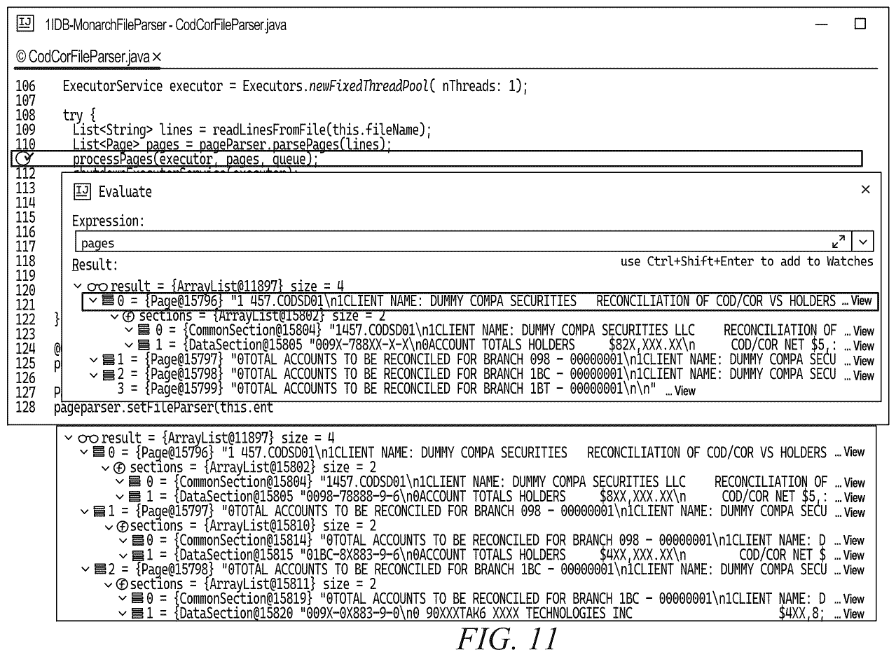

Each of these Pages, generally, have two sections. Intro Section and the Data Section as shown by FIG. 11.

In the file parser, these sections are handled differently. Intro section uses regex and splitting of the keyword to get the keyword vales and they are stored as a map of key-value pair and remain common for the whole page. Then the data section is parsed, where each block of data is processed based on the configuration. In some examples, the data can be any combination of lines in the incoming file, determined to form one row of data in the table.

For example:

CodCorFileParser.java

216 @ private DataProcessorDto<T> process Page(Page page) throws

ClassNotFoundException {

| | |
|---|---|
| 217 | |
| 218 | Map<Integer, Map<String, String>> resultMap = new |

ConcurrentHashMap<>( );

| | |
|---|---|
| 219 | Map<String, String> keywordMap = new ConcurrentHashMap<>( ); |
| 220 | Map<String, Map<String, String>> accountData= new |

ConcurrentHashMap<>( );

| 221 | DataProcessor<T> processor =null; |
|---|---|
| 222 | try { |
| 223 | processor = dataProcessorFactory.getProcessor(entityName); |
| 224 | } catch (Exception e) { |
| 225 | log.error(“Error while getting processor for entity: ” + entityName, e); |
| 226 | } |
| 227 | for (Section section : page.getSections( )) { |
| 228 | String sectionType=section.getClass( ).getSimpleName( ); |
| 229 | if(DATA_SECTION.equalsIgnoreCase(sectionType)){ |
| 230 | resultMap.putAll(handleMultiLineMultiSectionData(section)); |
| 231 | accountData = findTotalAccountRecords(section); |
| 232 | } |
| 233 | if (INTRO_SECTION.equalsIgnoreCase(sectionType) \|\| |
| | COMMON_SECTION.equalsIgnoreCase(sectionType)) { |
| 234 | |
| keywordMap.putAll(multiIntroKeywordRegexProcessor.processIntroSection(section, | |
| | ymlFileConfig)); |
| 235 | } |
| 236 | } |
| 237 | if (!resultMap.isEmpty( ) && processor != null) { |

The data processing happens in the FileParser class which takes into account:
Does the data section of the page start with a new data element or is it a continuation from the last page resulting in orphan records?
Does the data section of the current page end with all the required data elements or is it resulting in introduction of some parent data element for which the child (remaining) data elements have to be looked for in the next page's data section.
Are there any data elements (some keywords, either from data section or keywords section) that are needed from previous pages?
Do any data elements need to be passed from this page to another page, which may be used later?
Is the parsing of the lines of data section linear or is specific logic needed to be applied to any specific part of data?
What is the data flow when these scenarios are considered. Is the pattern changing, any line goes missing, or is something added to the block of data?
What are the rules or parsing techniques to apply while retrieving each column data? and
Is there any challenge in trying to find anything in particular?
   For example:

CodCorFileParser.java

301 private Map<Integer, Map<String, String>>

handleMultiLineMultiSectionData(Section section) {

| | |
|---|---|
| 302 | Map<Integer, Map<String, String>> resultMap = new ConcurrentHashMap<>( ); |
| 303 | LineDataParams params = LineDataParams.create Instance(ymlFileConfig, |

resultMap);

| | |
|---|---|
| 304 | Counter counter = new Counter( totalAccountLineCounter: 0, |

incrementLineCounter: false);

| 305 | try { |
|---|---|
| 306 | String content = section.getContent( ).toString( ); |
| 307 | String[ ] lines = content.split( regex “\n”); |
| 308 | LIST<String> handleTotalAccountConditionList= |
| ymlFileConf.getColumnMapping( ).getHandleSpecialCondition( ); | |
| 309 | int. maxLinesCanBeIgnored = getMaxLinesCanBeItnored( )’ |
| 310 | for (String line : lines) { |
| 311 | boolean recordMatched = false; |
| 312 | if (counter.isIncrementLineCounter( )){ |

313

counter.setTotalAccountLineCounter(counter.getTotalAccountLineCounter( ) +1);

| | |
|---|---|
| 314 | boolean skipLine = false; |
| 315 | skipLine = checkLineMatchesPatternAcctNbr(skipLine, line, |

params);

| | |
|---|---|
| 316 | skipLine = checkLineContainsConditionTwo(skipLine, line, |
| | handleTotalAccountConditionList, counter); |
| 317 | skipLine = checkLineContainsConditionZero(skipLine, line, |
| | handleTotalAccountConditionList); |
| 318 | skipLine =checkLineContainsConditionOne(skipLine, line |
| | handleTotalAccountConditionList, counter); |
| 319 | if (skipLine ){ |
| 320 | continue; } |
| 321 | line = padLineToMaxColumnCheck(line, |

params.getMaxColumnCheck( ));

| | |
|---|---|
| 322 | String startSubstring = |

line.substring(params.getNewRecordStartPosition( ),

| | |
|---|---|
| | params.getNewRecordStartPosition( )+1); |
| 323 | if (!(startSubstring.trim( ).isEmpty( ))){ |
| 324 | params.setKey(1); |
| 325 | }else{ params.setKey(processLine(line,params)); |

}

| 326 | params.setTempMap(new HashMap<>( )); |
|---|---|
| 327 | line = replaceCharsWithSpace(line, params.getDeletableChars( )); |
| 328 | |
| params.setTempMap(getColumnValuesAsMap(params.getColumnValueList( ), | |
| | params.getKey( ), line)); |
| 329 | recordMatched - processColumns(masLinesCanBeIgnored,line, |

params);

| | |
|---|---|
| 330 | params.getKey(params.getKey( )+1; // Increment counter |
| 331 | if (params.getKey( ) > |

params.getNumberOfLinesInaSingleMultiLineBlock( )) {

| | |
|---|---|
| 332 | params.setKey(1); // Reset counter |
| 333 | } |
| 334 | processMultilineComment(line, params, recordMatched); |
| 335 | } |
| 336 | params.getResultMap( ).put(params.getMapKey( ), params.getLineMap( )); |
| 337 | params.setMapKey(params.getMapKey( ) + 1); |
| 338 | } catch (Exception e) { |
| 339 | log.error(“Error in processing data section of |

MultiLineIntroHeaderDataSectionFileParserYML”,e);

| | |
|---|---|
| 340 | } |
| 341 | return params.getResultMap( ); |
| 342 | |

Once both the intro and data Section of the Page is parsed, the values are sent to Data Processor to identify the correct mapping and create Entity Objects. The Data Processors are also annotated with annotation “@EntityDataProcessor(entityName={“CODSD01”})” so as to identify the correct data processor based on the Incoming file name. For example:

CodCorFileParser.java

| | |
|---|---|
| 22 | @Component |
| 23 | @EntityDataProcessor(entityName = {“CODSD01} ) |
| 24 | @Slf4 |
| 25 | public class Codsd01DataProcessor implements DataProcessor<CODSD01_DTL> |
| 26 | @Override |
| 27 | public DataProcessorDto<CODSD01_DTL> |
| | parseDataSectionToGenericEntityList(BPS_COMPOSITE bps Composite ) { |
| 28 | return null; |
| 29 | } |
| 30 | |
| 31 | @Override |
| 32 | public DataProcessorDto<CODSD01_DTL> |

parseDataSectionToGenericEntityListWithMap

| | |
|---|---|
| | (BPS_COMPOSITE bps Composite) { |
| 33 | |
| 34 | if (bpsComposite == null) { |
| 35 | log.error(“bpsComposite for CODSD01_DTL is null”); |
| 36 | return null; |
| 37 | } |
| 38 | |
| 39 | |
| 40 | List<CODSD01_DTL> codsd01Dtls = new ArrayList<>( ); |
| 41 | List<CODSD01_SMRY> codsd01Smrys = new ArrayList<>( ); |
| 42 | SimpleDateFormat sdf = new SimpleDateFormat( pattern: |

“MM/dd/yy”);

| | |
|---|---|
| 43 | |
| 44 | DataProcessorDto<CODSD01_DTL> dataProcessorDto = new |

DataProcessorDto<>( );

| | |
|---|---|
| 45 | |
| 46 | |
| 47 | if (bpsComposite.resultMap2 != null && |

!bpsComposite.resultMap2.isEmpty( )) {

| | |
|---|---|
| 48 | processCodsd01Details(bpsComposite, sdf, codsd01Dtls); |
| 49 | } |
| 50 | |
| 51 | if (bpsComposite.resultMap4 != null && |

!bpsComposite.resultMap4.isEmpty( )) {

| | |
|---|---|
| 52 | processCodsd01Summarys(bpsComposite, sdf, codsd01Smrys); |
| 53 | } |
| 54 | |
| 55 | dataProcessorDto.setCompositeData(codsd01Dtls, |

CODSD01_DTL.class);

| | |
|---|---|
| 56 | dataProcessorDto.setCompositeData(codsd01Smrys, |

CODSD01_SMRY.class);

| | |
|---|---|
| 57 | return dataProcessorDto; |
| 58 | } |

There are some instances where data processors are not defined. For those incoming files a generic data processor can create the mapping for any Entity object. For example:

GenericDataProcessor.java

| | |
|---|---|
| 28 | @slf4j |
| 29 | @Component |
| 30 | @Scope(ConfigurableBeanFactory.SCOPE_PROTOTYPE) |
| 31 | public class GenericDataProcessor<T> implements DataProcessor<T> { |
| 32 | @Override |
| 33 | @ public DataProcessorDto<T> |

parseDataSectionToGenericEntityList(BPS_COMPOSIT bpsComposit) {

| | |
|---|---|
| 34 | List<T> entities = new ArrayList<>( ); |
| 35 | SimpleDateFormat sdf = new SimpleDateFormat( pattern: “MM/dd/yy”); |
| 36 | DataProcessorDto<T> dataProcessorDto = new DataProcessorDto<>( ); |
| 37 | Map<String, String> resultKeywordMap = bpsComposite.keywordMap; |
| 38 | T entity = null; |
| 39 | for (Integer key : bpsComposite.resultMap2.keySet( )) { |
| 40 | Map<String, String> currentMap = bpsComposite.resultMap2.get(key); |
| 41 | if (currentMap.values( ).stream( ).allMatch(String::isEmpty)) { |
| 42 | continue; |
| 43 | } |
| 44 | try { |
| 45 | entity = (T) Class.forName( className: |

“com.idb.filepaper.entities.” +

| | |
|---|---|
| | bpsComposite.entityName).newInstance( ); |
| 46 | Map<String, String> valueMap = |

bpsComposite.resultMap2.get(key);

| | |
|---|---|
| 47 | |
| 48 | if(null ==valueMap \| \| valueMap.isEmpty( )){ |
| 49 | continue; |
| 50 | } |
| 51 | setEntityFieldsFromDataMap(sdf, entity, valueMap); |
| 52 | setEntityFieldsFromDataMap(sdf, entity, resultKeywordMap); |
| 53 | |
| 54 | entities.add(entity); |
| 55 | } catch (Exception e) { |
| 56 | log.error(“Error while processing the data for key { }”, key, e); |
| 57 | } |
| 58 | } |
| 59 | |
| 60 | dataProcessorDto.setEntityList(entities); |
| 61 | dataProcessorDto.setEntityClass((Class<T>) entity.getClass( )); |
| 62 | return dataProcessordto; |
| 63 | } |

If there is any custom logic required for any fields, it can be handled by annotating the Entity class's data field by “@CustomField(processorMethod=“EntityMethods.processCurrentRunDate”)” and “@CombinedField(fields={“CurrPx”, “TradePX”}, processorMethod=“EntityMethods.processPriceDiffPrcCnt”)” depending upon the requirement and providing the implementation of that particular field in another class called Entitymethod. For example:

CASHDIVR.java

| | |
|---|---|
| 84 | private BigDecimal pageNbr; |
| 85 | |
| 86 | @Column(name = “RunDate”) |
| 87 | @CustomField(processorMethod = “EntityMethods.processCurrentRunDate”) |
| 88 | private Instant runDate; |
| 89 | |
| 90 | / / getters and setters |
| 91 | } |

BTB30RX.java

| | |
|---|---|
| 92 | @Column(name = “[P&L]”, length = 6) |
| 93 | private String pl; |
| 94 | |
| 95 | @Column(name = “PriceDiff”) |
| 96 | @DecimalPrecision(3) |
| 97 | @CombinedField(fields = {“CurrPx”, “TradePX”}, processorMethod = |
| | “EntityMethods.processPriceDiff”) |
| 98 | private BigDecimal priceDiff; |
| 99 | |
| 100 | @Column(name = “PriceDiffPrcCnt”) |
| 101 | @DecimalPrecision(5) |
| 102 | @CombinedField(fields = {“CurrPx”, “TradePX”}, processorMethod = |
| | “EntityMethods.processPriceDiffPrcCnt”) |
| 103 | private BigDecimal priceDiffPrcCnt; |
| 104 | |
| 105 | } |

Custom implementation of data elements of the entity class are defined in the EntityMethods class. For example:

EntityMethods.java

| | |
|---|---|
| 233 | @EntityClass(entityName = {“BTB30RX”}) |
| 234 @ | public BigDecimal processPriceDiff(Map<String, String> valueMap, Field |

field) {

| | |
|---|---|
| 235 | String currPxValue = valueMap.get(“CurrPx”); |
| 236 | String tradePxValue = valueMap.get(“TradePX”); |
| 237 | if (StringUtils.isEmpty(currPxValue) \| \| |

StringUtils.isEmpty(tradePxValue)) {

| | |
|---|---|
| 238 | log.error(“CurrPx or TradePX value is null or empty”); |
| 239 | return null; |
| 240 | } |
| 241 | try { |
| 242 | |
| 243 | DecimalPrecision decimalPrecision = |

field.getAnnotation(DecimalPrecision.class);

| | |
|---|---|
| 244 | int precision=5; |
| 245 | if (decimalPrecision != null) { |
| 246 | / /Apply the precision to the result |
| 247 | precision=decimalPrecision.value( ); |
| 248 | } |
| 249 | BigDecimal currPx = getBigDecimalValue(currPxValue,precision); |
| 250 | BigDecimal tradePx = |

getBigDecimalValue(tradePxValue,precision);

| | |
|---|---|
| 251 | BigDecimal result = currPx.subtract(tradePx); |
| 252 | / /Get the DecimalPrecision annotation from the field |
| 253 | / /Apply the precision to the result |
| 254 | result = result.setScale(precision, RoundingMode.HALF_UP); |
| 255 | |
| 256 | return result; |
| 257 | } catch (NumberFormatException e) { |
| 258 | log.error(“Error parsing CurrPx or TradePX value to |

BigDecimal”, e);

| | |
|---|---|
| 259 | return null: |
| 260 | } |
| 261 | } |

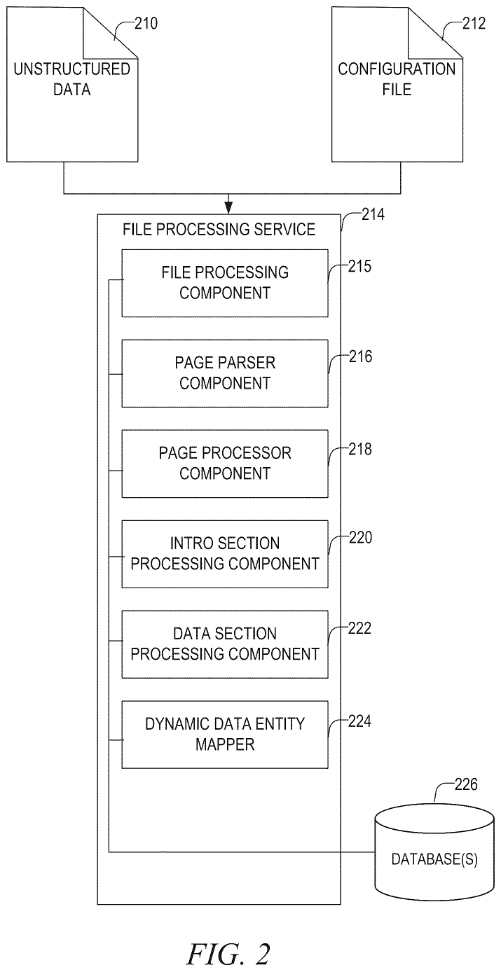

After the data is transformed into Entity Objects, it is saved to the database. FIG. 2 shows a logical diagram of a file processing service 214 that processes unstructured data files, such as unstructured data 210, using configuration files, such as configuration file 212. The file processing service 214 comprises several components that work in conjunction to parse and process the data effectively. The file processing component 215 controls the process of parsing the files by calling one or more other components.

The page parser component 216 receives the unstructured data 210 and utilizes the configuration file 212 to divide the data into logical pages. This division is based on the logical page definitions provided in the configuration file, allowing for a structured approach to data extraction. The page processor component 218 processes the pages generated by the page parser component 216. This component coordinates the subsequent processing steps, ensuring that each page is handled according to the defined rules and patterns.

The intro section processing component 220 identifies and processes the introduction and header sections of each page. Using the introduction section definitions and header column definitions from the configuration file 212, this component extracts constant data elements and markers necessary for accurate data extraction.

The data section processing component 222 focuses on extracting data objects from the data sections of each logical page. The data section processing component 222 applies customizable parsing techniques, such as regular expressions and data row handling, to ensure data continuity across pages and handle any conditions.

The dynamic data entity mapper 224 creates data entity objects from the parsed data. This component maps the extracted data to the appropriate database schema, preparing the data for storage.

The database(s) 226 store the processed data objects for further analysis and retrieval. The integration of these components within the file processing service 214 provides a flexible and efficient solution for parsing unstructured data files, leveraging the configuration file 212 to adapt to various file types and scenarios. The database(s) 226 may be part of the file processing service 214 or may be a separate entity or service.

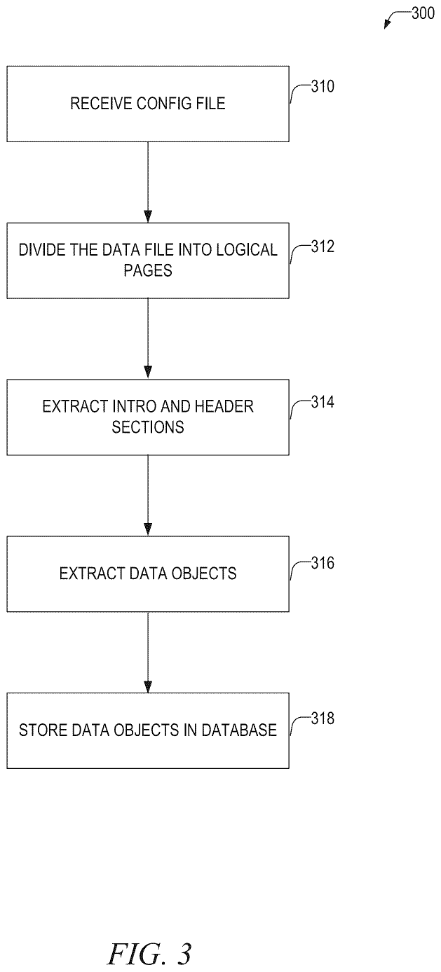

FIG. 3 illustrates a flowchart of a method for parsing an unstructured file according to some examples of the present disclosure. At operation 310, the method begins by receiving a configuration file. This file defines patterns and rules necessary for parsing the unstructured data file, including logical page definitions, introduction section definitions, header column definitions, and data locator definitions. At operation 312, the method involves dividing the data file into logical pages. A page parser uses the logical page definitions from the configuration file to segment the unstructured data file into logical pages, organizing the data into manageable units for further processing. At operation 314, the method extracts intro and header sections from each identified page. An introduction parser uses the introduction section definitions and header column definitions to identify and extract these sections, which typically contain constant data elements and serve as markers for the data that follows.

At operation 316, the method extracts data objects from the data sections of each logical page. A data processor applies customizable parsing techniques based on the data locator definitions to ensure data continuity across logical pages, processing each extracted data object individually to maintain accuracy and consistency. At operation 318, the final step involves storing the processed data objects in a database. This storage facilitates further analysis and retrieval, ensuring that the parsed data is organized and accessible for subsequent use. In some examples, the parsed data in the database facilitates business intelligence and data analytics.

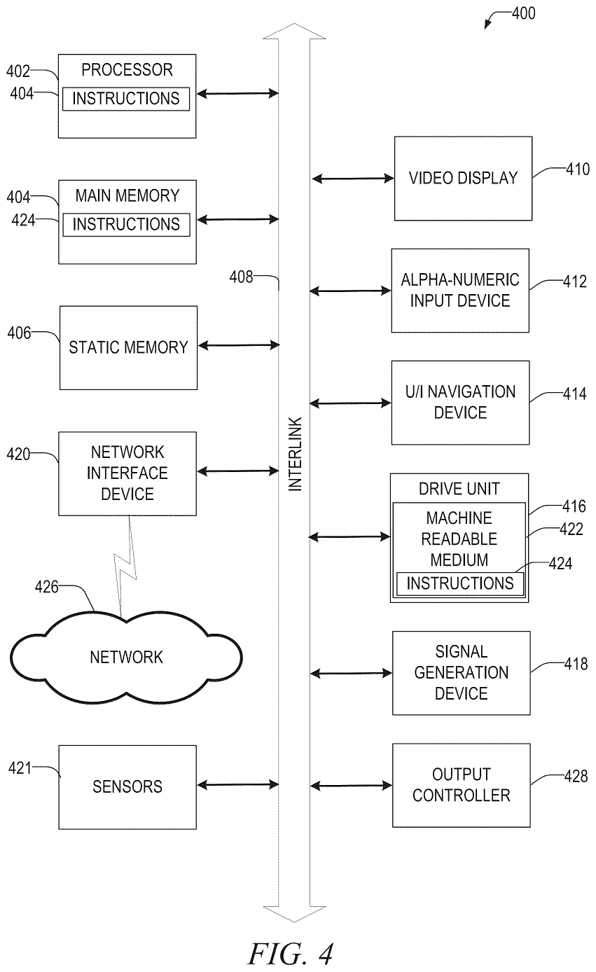

FIG. 4 illustrates a block diagram of an example machine 400 upon which any one or more of the techniques (e.g., methodologies) discussed herein may be performed. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a desktop, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 400 may be configured to perform the messaging of FIG. 1; include the components of FIG. 2; and perform the method of FIG. 3. Machine 400 may be configured by the code shown in the present disclosure.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5. Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over a communications network 426 using a transmission medium via the network interface device 420. The Machine 400 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

What is claimed is:

1. A computer-implemented method for parsing an unstructured data file to create a database record, the method comprising:
receiving a configuration file that defines patterns and rules for parsing the unstructured data file, the configuration file including logical page definitions, introduction section definitions, header column definitions, and data locator definitions;
dividing, using a page parser, the unstructured data file into logical pages based on the logical page definitions;
extracting, using an introduction parser, introduction and header sections from each identified page using the introduction section definitions and header column definitions;
extracting, using a data processor, data objects from the data sections of each logical page based upon the data locator definitions, the extracting processing each extracted data object individually to ensure data continuity across logical pages; and
storing the processed data objects in a database for further analysis and retrieval.

2. The method of claim 1, further comprising:
submitting the unstructured data file to a machine-learning algorithm to produce the configuration file.

3. The method of claim 2, further comprising:
training the machine-learning algorithm using training data comprising a plurality of different unstructured data files and a plurality of corresponding configuration files.

4. The method of claim 1, further comprising detecting and removing unwanted characters from data sections to ensure data integrity, the unwanted characters specified in the configuration file.

5. The method of claim 1, wherein the configuration file is a YAML Ain't Markup Language (YML) file.

6. The method of claim 1, wherein the header column definitions include options for handling multi-line headers.

7. The method of claim 1, wherein the logical pages do not correspond to page indicators in the unstructured data file.

8. A computing device for parsing an unstructured data file to create a database record, the computing device comprising:
a hardware processor;
a memory, the memory storing instructions, which when executed by the hardware processor cause the computing device to perform operations comprising:
receiving a configuration file that defines patterns and rules for parsing the unstructured data file, the configuration file including logical page definitions, introduction section definitions, header column definitions, and data locator definitions;
dividing, using a page parser, the unstructured data file into logical pages based on the logical page definitions;
extracting, using an introduction parser, introduction and header sections from each identified page using the introduction section definitions and header column definitions;
extracting, using a data processor, data objects from the data sections of each logical page based upon the data locator definitions, the extracting processing each extracted data object individually to ensure data continuity across logical pages; and
storing the processed data objects in a database for further analysis and retrieval.

9. The computing device of claim 8, wherein the operations further comprise:
submitting the unstructured data file to a machine-learning algorithm to produce the configuration file.

10. The computing device of claim 9, wherein the operations further comprise:
training the machine-learning algorithm using training data comprising a plurality of different unstructured data files and a plurality of corresponding configuration files.

11. The computing device of claim 8, wherein the operations further comprise detecting and removing unwanted characters from data sections to ensure data integrity, the unwanted characters specified in the configuration file.

12. The computing device of claim 8, wherein the configuration file is a YAML Ain't Markup Language (YML) file.

13. The computing device of claim 8, wherein the header column definitions include options for handling multi-line headers.

14. The computing device of claim 8, wherein the logical pages do not correspond to page indicators in the unstructured data file.

15. A machine-readable medium, storing instructions for parsing an unstructured data file to create a database record, the instructions, which when executed, cause the machine to perform operations comprising:
receiving a configuration file that defines patterns and rules for parsing the unstructured data file, the configuration file including logical page definitions, introduction section definitions, header column definitions, and data locator definitions;
dividing, using a page parser, the unstructured data file into logical pages based on the logical page definitions;
extracting, using an introduction parser, introduction and header sections from each identified page using the introduction section definitions and header column definitions;
extracting, using a data processor, data objects from the data sections of each logical page based upon the data locator definitions, the extracting processing each extracted data object individually to ensure data continuity across logical pages; and
storing the processed data objects in a database for further analysis and retrieval.

16. The machine-readable medium of claim 15, wherein the operations further comprise:
submitting the unstructured data file to a machine-learning algorithm to produce the configuration file.

17. The machine-readable medium of claim 16, wherein the operations further comprise:
training the machine-learning algorithm using training data comprising a plurality of different unstructured data files and a plurality of corresponding configuration files.

18. The machine-readable medium of claim 15, wherein the operations further comprise detecting and removing unwanted characters from data sections to ensure data integrity, the unwanted characters specified in the configuration file.

19. The machine-readable medium of claim 15, wherein the configuration file is a YAML Ain't Markup Language (YML) file.

20. The machine-readable medium of claim 15, wherein the header column definitions include options for handling multi-line headers.
